(19) United States
(12) Patent Application Publication
(10) Pub. No.: US 2014/0246274 A1
(43) Pub. Date: Sep. 4, 2014

(54) ECCENTRICALLY SUSPENDED ELEVATOR CAR

(71) Applicant: Inventio AG, Hergiswil (CH)

(72) Inventor: Ernst Ach, Ebikon (CH)

(21) Appl. No.: 14/279,407

(22) Filed: May 16, 2014

Related U.S. Application Data
(63) Continuation of application No. 13/142,291, filed on Jun. 27, 2011.

(30) Foreign Application Priority Data
Dec. 26, 2008 (EP) 08172952.7

(51) Int. Cl. B66B 11/04

(52) U.S. Cl. CPC B66B 11/04
USPC 187/251

(57) ABSTRACT

An elevator installation has at least one elevator car and at least one counterweight which are displaced in opposing directions along at least one guide track in an elevator shaft by a supporting and driving apparatus that is guided by a drive pulley of a drive. The supporting and driving apparatus is fastened directly to the elevator car eccentrically with respect to a center of gravity of the elevator car so that a tilting or load moment results thereby, wherein the tilting or load moment is compensated by a compensation device.

### CROSS-REFERENCE TO RELATED APPLICATIONS

This application is a continuation of the co-pending U.S. patent application Ser. No. 13/142,291 filed Jun. 27, 2011.

### FIELD OF THE INVENTION

The present invention relates to an elevator installation in which at least one elevator car is suspended not centrally about its center of gravity, but decentrally or eccentrically or off-center at a support means. This means in general that the fastening point or points of the elevator car does not or do not correspond with the point of force application of the holding or driving force for the elevator car, such as is the case in, for example, a so-termed rucksack suspension.

### BACKGROUND OF THE INVENTION

An elevator installation usually comprises an elevator car and at least one counterweight which are moved in opposite sense in an elevator shaft. The elevator car and the at least one counterweight in this connection run in or along guide rails.

The guide rails, which are designed as T-sections, in this type of eccentric suspension basically take over acceptance of a tipping moment which manifests itself as a tension force at an upper guide shoe of the elevator car or at the relevant point of the guide rail and as a pressure force at a lower guide shoe of the elevator car or at the relevant point of the guide rail. Added to the tipping moment of the elevator car itself is a respective load moment generated by, for example, persons being transported.

Consequently, eccentrically suspended elevator car require on the one hand guide rails of appropriately stable construction and on the other hand guides which withstand the forces which arise. However, this fact represents an added burden or disadvantage in terms of construction so that solutions with respect thereto are sought.

Patent Specification CH 517 043 discloses a solution for an elevator car in which a hydraulic thrust piston drive is arranged laterally in the elevator shaft outside the movement space of the elevator car. By means of a looping body, that is to say cable, which is guided over rollers arranged in mirror image a cradle with a joint is realized which thus allows application of the drive force varying from the direction. This patent specification thus discloses an improved transmission of a force application point, which lies outside the movement space of the elevator car, to another force application point, which lies within the movement space of the elevator car below the center of gravity of the elevator car. It is thereby achieved that additional, self-acting loads at the guide rails or in the guides are at least partly eliminated, that is to say canting of the elevator car in the diagonally oppositely arranged guide rails is avoided during upward thrust operation. This patent specification thus does not describe decentral or eccentric suspension of the elevator car or any possibility of elimination of a tipping or load moment caused by the eccentric suspension.

An elevator installation is known from the published Patent Application WO 2008/012592 A, which uses so-termed runners in order to support an elevator car relative to the shaft walls. Use is made as runners of either rollers which roll along the shaft walls or slides which slide along the shaft walls.

### SUMMARY OF THE INVENTION

An object of the present invention is to find a compensating device for compensating for the tipping and loading moments which arise in an eccentrically suspended elevator car.

Fulfillment of the object consists in the concept, arrangement and design of a compensating device which provides looping around rollers at the elevator car by at least one second support means.

According to the invention the looping-around of at least two rollers arranged at the elevator car is carried out in opposite sense and, in particular, in such a manner that the looping-around by at least one second support means generates a torsion which acts against the tipping or loading moment of the elevator car. Thus, a torsion arises in that the at least one second support means—subsequently termed compensating means—is led at the top around a first roller, which is offset from a center axis or center of gravity line of the elevator car towards the guide rails, at the elevator car and in opposite sense, i.e. at the bottom, around a second roller, which is offset from the center axis or center of gravity line of the elevator car in the opposite direction. Force components thereby arise which counteract the pressure arising at the bottom at the elevator car and the tension arising at the top at the elevator car.

In principle, compensation for this pressure force and tension force can be achieved not only by means of rollers in opposite sense and a support means, but also by mechanical devices which pull or push and which, for example, travel on further guide rails in company with the elevator car. Consequently, in the following the term compensating means shall also embrace solutions of that kind.

In general, an elevator installation with an eccentrically suspended elevator car, for example in the form of a so-called rucksack suspension, corresponds with the following basic construction: The elevator car usually runs along two guide rails, which are arranged at one of the four sides of the elevator shaft. The drive and the counterweight are as a rule also arranged at the same side. The first supporting and driving means, which drives, is in that regard preferably directly fastened to the elevator car as close as possible to the guide rails.

According to a basic variant of the invention the second support means, which can have a round, wedge-shaped or also flat cross-section, is made of the materials or material compositions usually employed in this field. Coming into consideration, in particular, are belts with steel tensile carriers or a flat-link articulated chain, since they have small stretching in length and constant elongation. The supporting or, more precisely, compensating means is fastened at one end firmly to, for example, a first, lower fastening point as low as possible in the elevator shaft and as horizontally far away as possible from the guide rails. From this first, lower fastening point the compensating means loops at the top around a first roller which is arranged at the lower edge of the elevator car, preferably horizontally as close as possible to the guide rails. From this first roller the compensating means loops at the bottom around a second roller in opposite sense. This second roller is preferably arranged at the upper edge of the elevator car and preferably as horizontally far away as possible from the guide rails. From this second roller the compensating means leads to a second, upper fastening point which is selected to be preferably as high as possible in the elevator shaft and preferably horizontally as close as possible to the guide rails.

This basic variant of a compensating means arrangement ensures the most optimum possible lever ratios and smallest possible bending radii of the compensating means, but it also comes into consideration in arrangements in which the two rollers are arranged at the same height, for example, at the lower edge of the elevator car. In addition, the support means guidance can be designed to run not diagonally as previously described, but also vertically in the elevator shaft.

A further design variant building on the previous description leads the compensating means over rollers, which project beyond a side wall of the elevator car, i.e. rollers are not placed at the underside or at that wall of the elevator car which is opposite the guide rails, but at a side wall or, as a symmetrical pair, preferably at both side walls of the elevator car.

A further preferred design variant provides at both sides of the elevator car a guidance of the compensating means extending diagonally in the elevator shaft. This was due to the fact that the door of the elevator car is preferably placed at the front (the side opposite guide rails) of the elevator car.

The previously described compensating means is fixedly fastened at its two ends. Calculations with respect to this design variant have shown that the compensating means in this case acts with a slight variable torque against the tipping moment of the elevator car. Taking place within the fixed fastening points of the compensating means during travel of the elevator car is a displacement of a constant, invariable amount of length which is formed by the spacing of the first roller at the elevator car from the second roller at the elevator car. The length of the free section of the compensating means from the lower fastening point to the first roller thereby increases during, for example, upward movement of the elevator car. This length increase takes place at the cost of a decrease in the free section of the compensating means from the second roller to the upper fastening point.

This increase or decrease of one length at the cost of decrease or increase of the other lengths does not in practice happen absolutely 1:1. In other words, the torque which according to the invention opposes the tipping moment of the elevator car has, when the elevator car is located in the center of the elevator shaft, a defined value. This value is formed from a tension component (pulling away from the guide rails), produced by the lower free section of the compensating means, and a pushing component (pressing towards the guide rails), produced by the upper free section of the compensating means. Towards the lowest and towards the highest position of the elevator car in the elevator shaft the two components of the torque correspondingly shift. Thus, in the highest position of the elevator car the pressure component on the guide rails attains at the upper side of the elevator car a peak value, with simultaneous attainment of the lowest value of the tension component away from the guide rails at the lower edge of the elevator car. In the deepest position of the elevator car in the elevator shaft it is correspondingly reversed.

As already mentioned, however, the different is small. Thus, for example, expressed in a length deviation the length difference is only 0.156 meters for a total length of the compensating means of 14 meters and a possible attainability of a minimum length of the upper free section or the lower free section of 2.28 meters. The length of 2.28 meters corresponds with the length of the hypotenuse in a right-angle triangle, which is formed by a horizontally disposed cathetus in the form of a car depth (1.2 meters) and a vertically upright cathetus in the form of a minimum free remaining shaft head height. In other words, the calculation is based on the assumption that the upper edge of the elevator car or the lower edge of the elevator car can at most go to two meters from the shaft ceiling or the shaft base, from which consequently a minimum length of the free sections of the compensating means of 2.28 meters results.

The longer the compensating means overall, i.e. the higher the elevator shaft is on the one hand or the longer the free sections can be kept with respect to their minimum distance on the other hand, the smaller the length difference. This means that the described variants of embodiment are characterized by particular simplicity and are particularly well suited to high elevator installations and/or to elevator installations with a deep shaft pit and a high shaft head.

A further variant of embodiment building on this basic variant, however, also provides compensation for the difference in length or torque which occurs.

A variant of embodiment for achieving this provides a compensating means having a defined elasticity region which is wider than the length difference.

A further variant of embodiment by which compensation can be provided for the length difference provides a weight-loaded compensating element. For this purpose, one of the two fixedly fastened ends of the compensating means is no longer fixed, but acts in a deflecting roller with a defined weight. Alternatively or in combination a spring-loaded rocker can also fulfill the same task.

With respect thereto, further in accordance with the invention the weight in relation to its mass is so selected that in correspondence with the most frequent car or building utilization it compensates for a defined value of the tipping or load moment of the elevator car so that the tension or compression forces which arise at the guide rails or the guide shoes of the elevator car are equal to zero at this value. This value can lie in the long-term average at half the useful load or, rather, thereunder. If the elevator car is empty or loaded to the maximum then only half the tipping or load moment still acts on the guides.

According to the invention the weight is adjustable at an approximately horizontally arranged lever and equipped with an electrical/electronic control or safety switch for recognition of seating of the lever, which control switch is connected with the overall safety circuit of the elevator installation.

A further variant of embodiment by which compensation can be provided for the length difference provides a spring-loading of one or both rollers at the elevator car. The rollers can thereby ensure, in a horizontal direction, a defined compensation in the tension of the compensating means.

A variant of embodiment used for this purpose provides for compensation of the length difference by a controlled adjustment of the rollers at the elevator car in horizontal direction. Provided for this controlled adjustment can be, for example, pistons or a spindle which is or are controlled by means of the information on how high the elevator car is currently disposed in the elevator shaft. The rollers are correspondingly horizontally moved according to need. In this manner the Z-shaped arrangement of the compensating means can be adaptively spread to a greater or lesser extent in horizontal direction, but also the ratio of the tension force of the upper free section of the compensating means to the tension force of the lower free section of the compensating means can be influenced.

A further setting possibility of the compensating torque results from sensors which are arranged in the guide shoes of the elevator car. These sensors measure the tension or compression force which arises and can on the one hand thus ensure a compensation which derives from the moment difference due to different height positions of the elevator car in the elevator shaft.

On the other hand, however, a possibility of adaptation to different loads or different load distributions in the elevator car also comes about. If, for example, passengers stand in the elevator car at a distance from the guide rails, then a greater tipping moment or load moment would arise than if they were to stand near the guide rails. The sensors detect this new load situation and give an appropriate control command for a corresponding horizontal movement of the rollers so that the effect of the compensating means changes in such a manner that compensation is provided for the new load situation.

The guide shoes can additionally be equipped with damping means which damp possible moment peaks arising when moving off or coming to a stop.

Avoidance of the occurrence of moment peaks not only from the tipping moment or loading moment, but also from the counter-acting moment produced by the compensating means, can be achieved by particularly easy-running roller guides or slide material. The roller guides preferably have a low coefficient of friction and almost equal coefficients of friction with respect to static and dynamic friction.

Influencing, in accordance with the invention, of the compensating torque also results from the design of a fixed fastening point to be horizontally movable. Compensation can thereby be provided for the length difference which arises, but in addition the tension angle, i.e. the angle of application of the tension force at the roller, gives a changed force parallelogram with a changed horizontally compensating force component.

A further variant of embodiment of an elevator installation according to the invention provides that the elevator car is eccentrically suspended in two different respects, i.e. the elevator car is suspended at a corner due to, for example, space reasons of the building as a consequence of construction. Thus, the tipping moment or load moment of the elevator car arises as a diagonal. The previously described solutions proceed from placing of the suspension point of the elevator car on a notional extension line from the center of gravity of the elevator car perpendicularly to that edge of the elevator car which bears against the guide rails. If this notional prolongation line (gravitational line), however, lies on the diagonal of the (usually rectangular or square) plan area of the elevator car or even a body diagonal of the car body, then this variant of embodiment according to the invention provides, apart from the one or two parallelly extending compensating means, a further compensating means led at right angles thereto. The compensating devices then acting in combination can thus provide in accordance with the invention a compensation for a diagonally arising tipping moment or load moment.

Also lying within the scope of the present invention is an embodiment in which the compensating means is fastened not in stationary position to the elevator shaft walls, but to the guide rails of the elevator car to travel therewith. The previously illustrated Z-shaped arrangement in accordance with the invention of the compensating means can in this regard be realized in that the elevator car runs not only along that side in or along guide rails at which the counterweight, the drive and the eccentric suspension are disposed, but also at the opposite side. The elevator car thus runs, for example, at all four edges at the guide rails; due to the eccentric suspension of the elevator car and the thereby-caused tipping moment, however, tension and compression forces still arise in the guides, which in accordance with the invention it is relevant to eliminate or at least attenuate.

In a first variant of embodiment with respect thereto this can be achieved in accordance with the invention in that the compensating means is fastened separate guide shoes to travel therewith, which shoes are arranged at a spacing above and below the elevator car. Acceptance of the tension and compression forces caused by the tipping moment is thereby preferably distributed to a greater length of the guide rails.

The disadvantage of this arrangement according to the invention is, however, that a capability of movement of the elevator car into a particularly high and a particularly deep position has to be given up as a result. Consequently, a second variant of embodiment with respect thereto provides, apart from the two (or four) guide rails for the elevator car, further fastening rails provided only for the compensating means. At least two such opposite fastening rails thus take over the arrangement, which eliminates the tipping moment, of the compensating means otherwise also again led in Z-shape. Acceptance of the tipping moment is thereby no longer distributed to a greater length of the elevator car guide rails, but ensured by extra guide rails provided for that purpose. Thus, the guide shoes of the compensating means also no longer have to be disposed at a spacing from the guide shoes of the elevator car, but can be located at the same height. The disadvantage of giving up a possible capability of movement of the elevator car to a particularly high and a particularly deep position, or the necessity for a high shaft head and a deep shaft pit, is thus eliminated.

It is common to the described variants of embodiment according to the invention that the elevator car is suspended eccentrically and thereby a tipping moment or undesired forces arises or arise in the guides. Moreover, it is common thereto that these forces are opposed by way of compensating means. This is realized, for example, in a Z-shaped guidance of the compensating means over at least two rollers in the elevator car, in that a first roller is arranged to be displaced from the center of gravity of the elevator car towards the elevator car suspension and a second roller is arranged to be displaced from the center of gravity of the elevator car away from the elevator car suspension. The first roller is over-slung and the second is under-slung.

The described variants of embodiment according to the invention are thus capable of combination with one another. In particular, the setting and adaptation possibilities described in the paragraphs [0021] through [0030] are employable for all variants of embodiment.

An elevator suspension according to the invention brings the following advantages:
Compensation is provided for an eccentric suspension, which is imposed for reasons of cost or building conditions, with respect to the forces and loads which arise.
The guides for the elevator car no longer have to be of such cost-intensive and complicated construction in order to withstand loads which go beyond pure guidance of the elevator car.
Compensation for the loads which occur is realized economically and with few individual parts.
The drive forces can be reduced, because the guides run more easily.
Wear of the guides and thus the level of maintenance thereof diminish.
The forces transmitted by the guide rails to the building are smaller not only statically, but also dynamically.
The output of noise is less.
Compensation for the tipping moment or load moment is adaptable.
Compensation for the respective instantaneous tipping moment or load moment is controllable in continuously adaptive manner.
Suspension of the elevator car can be realized at only one of its corners.

### DESCRIPTION OF THE DRAWINGS

The invention is explained in more detail symbolically and by way of example on the basis of figures. The figures are described conjunctively and in general. The same reference numerals signify the same components and reference numerals with different indices indicate functionally equivalent or similar components.

FIG. 1 shows a schematic illustration of an elevator installation in a rucksack suspension with a compensating device according to the invention;

FIG. 2 shows a schematic illustration of the elevator installation according to the invention of FIG. 1 in plan view;

FIG. 3 shows a further variant of embodiment of an elevator installation or compensating device according to the invention;

FIG. 4 shows a further variant of embodiment of an elevator installation or compensating device according to the invention; and

FIG. 5 shows a further variant of embodiment of an elevator installation or compensating device according to the invention.

### DETAILED DESCRIPTION OF THE INVENTION

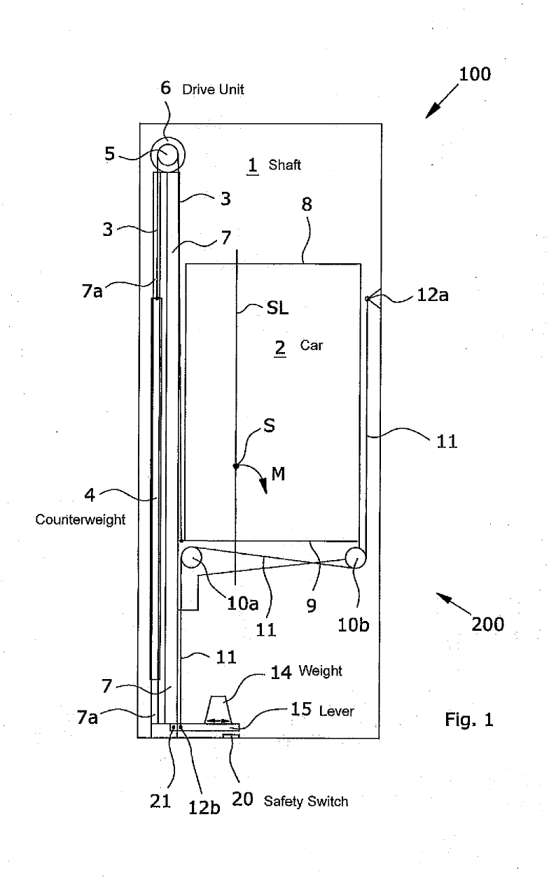

FIG. 1 shows an elevator installation 100 with a compensating device 200 according to the invention. An elevator car 2 is arranged in an elevator shaft 1 to be movable and is connected by way of a support means 3 with a movable counterweight 4. During operation the support means 3 is driven by a drive pulley 5 of a drive unit 6. The elevator car 2 is disposed in a so-termed rucksack suspension, which allows a tipping moment or load moment M to arise for the elevator car 2 from a center of gravity S. The elevator car 2 and the counterweight 4 are guided by means of guide rails 7 and 7a extending over the shaft height. The elevator car 2 has an upper edge 8 and a lower edge 9. A first roller 10a and a second roller 10b are arranged on the latter. The first roller 10a is positioned to be offset from a center of gravity line SL towards the guide rail 7. The second roller 10b, thereagainst, is arranged to be offset from the center of gravity line SL in the other direction away from the guide rail 7. A compensating means 11 is so guided that from a first fastening point 12a it loops under the second roller 10b and loops over the first roller 10a. From the first roller 10a the compensating means 11 is guided to a second fastening point 12b disposed at a lever 15. The lever 15 is rotatably articulated at an articulation point 21 and carries a weight 14 which can be displaced on the lever 15. Disposed under the lever 15 is a safety switch 20 which when the lever 15 seats down due to the absence of the tension stress in the compensating means 11 is triggered by the then downwardly rotating lever 15.

The guidance and tensioning of the compensating means 11 effects a compensation for the tipping moment or load moment M. The mass of the weight 14 can in this regard be so selected that that value of the tipping moment or load moment M which corresponds with the most frequent useful load of the elevator car 2 can be balanced to zero.

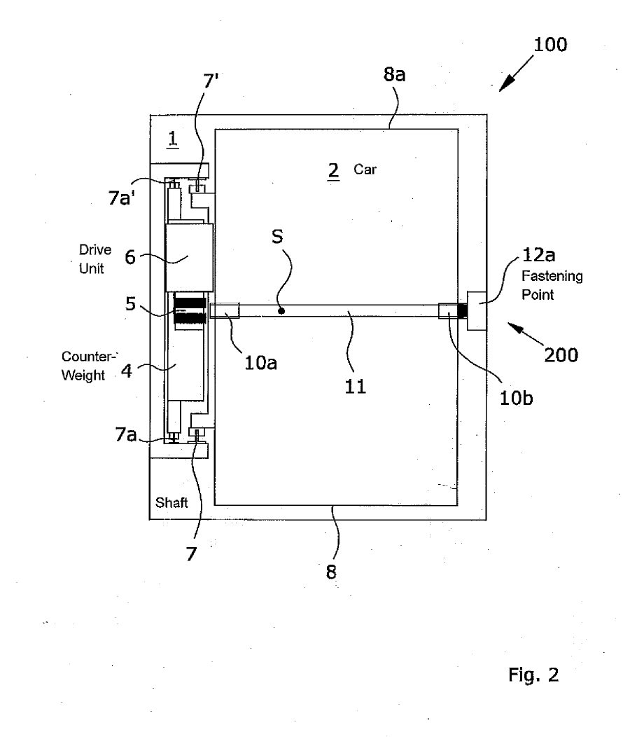

FIG. 2 schematically shows the elevator installation 100 according to invention, which was described in the preceding FIG. 1, with the compensating device 200, but this time in plan view so that the elevator car 2 considered from above no longer has only the upper edge 8, but also an upper edge 8a opposite thereto.

By contrast to the foregoing it is apparent that the compensating means 11 centrally loops under the elevator car 2. Moreover, it is apparent in this illustration that the guide rail 7 for the elevator car 2 forms a pair with a guide rail counter-member 7′ arranged in mirror symmetry and the guide rail 7a for the counterweight 4 with a guide rail counter-member 7a′ arranged in mirror symmetry.

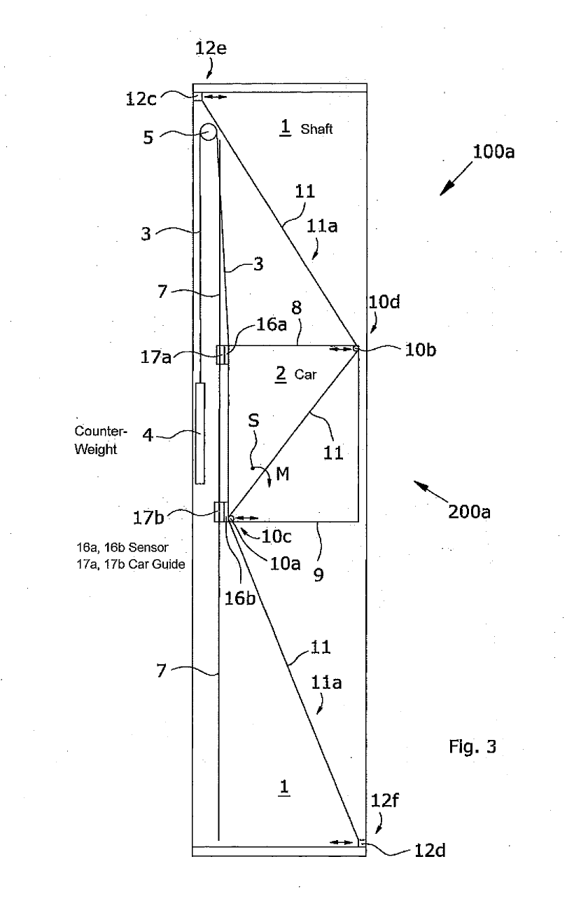

An elevator installation 100a according to the invention with a compensating device 200a according to the invention is shown in FIG. 3. The compensating means 11 is also guided in Z-shape as before around the first roller 10a and the second roller 10b. The first roller 10a is, as before, arranged at the lower edge 9 of the elevator car 2, but the second roller 10b this time at the upper edge 8 of the elevator car 2. The rollers 10a and 10b are so constructed that they project beyond the illustrated side wall of the elevator car 2. The compensating means 11 is fastened by its free ends to fastening points 12c and 12d as far apart as possible, but preferably to be displaceable in the horizontal. The fastening point 12c and also the fastening point 12d can also be acted on by a weight in accordance with the principle of FIG. 1. In addition, the rollers 10a and 10b are preferably arranged at the side wall of the elevator car 2 to be horizontally displaceable.

Car guides 17a and 17b are provided with a sensor 16a and 16b so that the tension loading in the car guide 17a and the pressure loading in the car guide 17b can be measured and on the basis of this measurement signal the horizontal movability of the rollers 10a and 10b and/or the fastening points 12c and 12d can be controlled.

In order that the compensation, which is now taking place laterally at the elevator car 2, for the tipping moment or load moment M remains in the plane of the drawing, an identical and symmetrical guide of a second compensating means 11a—which is not visible, because it is concealed in this side view—on identical and symmetrically arranged rollers 10c and 10d is preferably arranged at the rearward side wall of the elevator car 2. This second compensating means 11a would then be fastened to symmetrical fastening points 12e and 12f, wherein an optional weight compensation can then be realized by a weight cumulatively for both compensating means 11 and 11a.

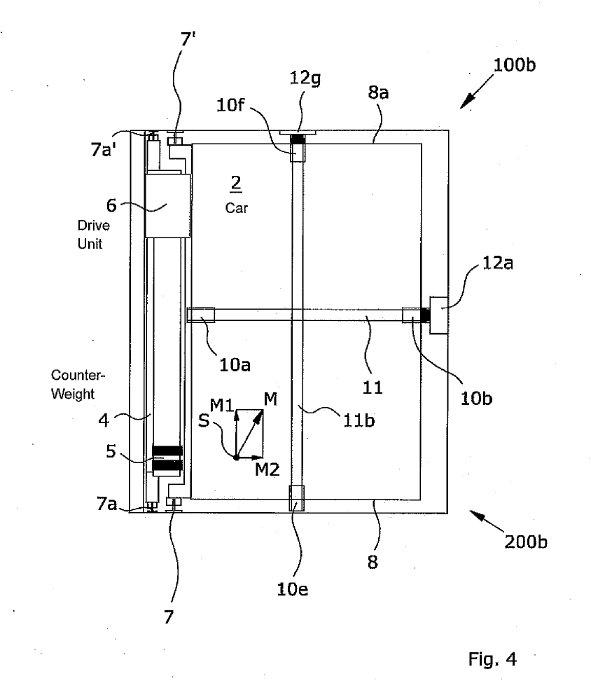

FIG. 4 shows schematically and in plan view a further variant of embodiment of an elevator installation 100b according to the invention with a compensating device 200b according to the invention. The elevator car 2 is suspended at a corner where it can be seen that the drive pulley 5 is placed. Consequently, the center of gravity S is displaced and a tipping moment or load moment M arises, which acts diagonally and consists of moment components M1 and M2. The compensating means 11 has provided compensation for the moment component M2, whilst a further compensating means 11b extending at right angles to the compensating means 11 provides compensation for the moment component M1. As previously disclosed, the compensating means 11b loops under the elevator car 2 with rollers 10e and 10f and is fixed at the shaft side at a fastening point 12g.

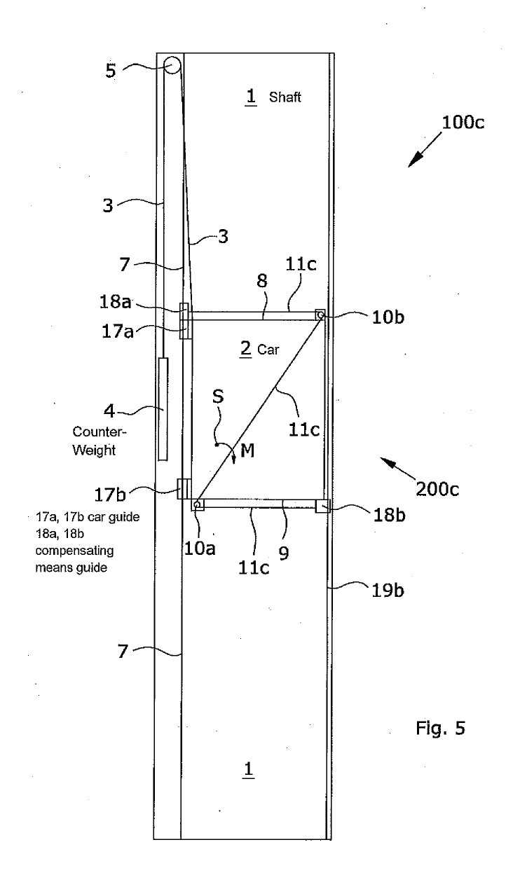

FIG. 5 schematically shows a further variant of embodiment of an elevator installation 100c according to the invention with a compensating 200c according to the invention. The elevator car 2, as disclosed before, is held in Z-shape by way of the rollers 10a and 10b by a compensating means 11c. The compensating means 11c is, however, fixed at a compensating means guide 18a travelling with the elevator car. The compensating means 11c is thus, by contrast to the previous variants of embodiment, no longer stationary.

In this illustration the compensating means guide 18a, like the car guides 17a and 17b, also runs on the guide rail 7. However, a preferred variant is to arrange near the guide rail 7a fastening rail 19a (not illustrated here) which is reserved only for the running and the holding by the compensating means guide 18a. On the opposite shaft side it is shown that a fastening rail 19b is arranged only for a compensating means guide 18b.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An elevator installation having an elevator car and a counterweight movable in opposite vertical sense at at least one guide rail in an elevator shaft by a supporting and driving apparatus guided over a drive pulley of a drive, the supporting and driving apparatus being fastened directly to the elevator car eccentrically with respect to a center of gravity of the elevator car whereby a tipping or load moment arises acting on the elevator car about the center of gravity, and a compensating device for compensating the tipping or load moment comprising:
a first roller of the compensating device fastened to the elevator car and arranged offset from the center of gravity of the elevator car towards the at least one guide rail;
a second roller of the compensating device fastened to the elevator car and arranged offset from the center of gravity of the elevator car away from the at least one guide rail; and
a compensating means of the compensating device extending in a Z-shaped arrangement forming a looping around said first roller and said second roller at the elevator car, said compensating means having opposite free ends fastened to associated first and second fastening points in the elevator shaft wherein at least one of said first roller, said second roller, said first fastening point and said second fastening point is horizontally displaceable for tensioning said compensating means.

2. The elevator installation according to claim 1 wherein said compensating means is a belt with a steel tensile carrier or a flat-link articulated chain.

3. The elevator installation according to claim 1 wherein said compensating means has a predefined elasticity.

4. The elevator installation according to claim 1 wherein said second fastening point includes a lever carrying a weight horizontally displaceable on said lever and said associated free end of said compensating means is attached to said lever, a mass of said weight being selected for balancing to zero the tipping or load moment corresponding to a most frequent useful load of the elevator car.

5. The elevator installation according to claim 4 wherein said lever is rotatably articulated at an articulation point and including a safety switch triggered by said lever for issuing a signal in an absence of a counter-loading of said compensating means.

6. The elevator installation according to claim 1 wherein said first roller and said second roller are arranged at a lower edge of the elevator car and said compensating means is guided by said first roller and said second roller to said associated first and second fastening points, said compensating means extending parallel to walls of the elevator shaft from each of said first and second rollers to said associated first and second fastening points.

7. The elevator installation according to claim 1 wherein said first roller is arranged at a lower edge of the elevator car and said second roller is arranged at an upper edge of the elevator car, said first and second rollers projecting beyond a body of the elevator car, and said compensating means is guided from said first roller and said second roller diagonally to walls of the elevator shaft to said associated first and second fastening points at opposite ones of the shaft walls.

8. The elevator installation according to claim 7 wherein said compensating device includes a third roller and a fourth roller arranged symmetrically with respect to said first roller and the second roller at an opposite side wall of the elevator car and another compensating means arranged symmetrically with respect to said compensating means.

9. The elevator installation according to claim 1 including a sensor in a car guide of the elevator car for generating a signal in response to which the horizontal displacement of said at least one of said first roller, said second roller, said first fastening point and said second fastening point is controllable.

10. The elevator installation according to claim 1 wherein the supporting and driving apparatus is fastened to a corner of the elevator car and including another compensating means extending at right angles to said compensating means.

11. The elevator installation according to claim 1 wherein the elevator shaft has another guide rail for the elevator car positioned opposite the at least one guide rail and said compensating means is fastened to the guide rails by compensating means guides to travel with the elevator car.

12. The elevator installation according to claim 11 wherein said compensating means guides travelling with the elevator car are arranged at fastening rails provided only for engaging said compensating means guides.

13. An elevator installation having an elevator car and a counterweight movable in opposite sense at at least one guide rail in an elevator shaft comprising:
a supporting and driving apparatus connected between the elevator car and the counterweight and guided over a drive pulley of a drive, said supporting and driving apparatus being fastened directly to the elevator car eccentrically with respect to a center of gravity of the elevator car whereby a tipping or load moment arises acting on the elevator car; and
a compensating device for compensating the tipping or load moment, said compensating device including:
a first roller fastened to the elevator car and arranged offset from the center of gravity of the elevator car towards the at least one guide rail;
a second roller fastened to the elevator car and arranged offset from the center of gravity of the elevator car away from the at least one guide rail; and
a compensating means extending in a Z-shaped arrangement forming a looping around said first roller and said second roller at the elevator car, said compensating means having opposite free ends fastened to associated first and second fastening points in the elevator shaft wherein at least one of said first roller, said second roller, said first fastening point and said second fastening point is horizontally displaceable for tensioning said compensating means.

14. The elevator installation according to claim 13 wherein said first roller and said second roller are arranged at a lower edge of the elevator car and said compensating means is guided by said first roller and said second roller to said associated first and second fastening points, said compensating means extending parallel to walls of the elevator shaft from each of said first and second rollers to said associated first and second fastening points.

15. The elevator installation according to claim 13 wherein said first roller is arranged at a lower edge of the elevator car and said second roller is arranged at an upper edge of the elevator car, said first and second rollers projecting beyond a body of the elevator car, and said compensating means is guided from said first roller and said second roller diagonally to walls of the elevator shaft to said associated first and second fastening points at opposite ones of the shaft walls.

16. The elevator installation according to claim 15 wherein said compensating device includes a third roller and a fourth roller arranged symmetrically with respect to said first roller and the second roller at an opposite side wall of the elevator car and another compensating means arranged symmetrically with respect to said compensating means.
